(19) United States
(12) Patent Application Publication
(10) Pub. No.: US 2009/0234470 A1
(43) Pub. Date: Sep. 17, 2009

(54) DEVICES AND METHODS FOR CONTROLLING CONTENT PLAYBACK AND AMBIENCE

(76) Inventors: Aaron Baalbergen, Miami, FL (US); Demian Martin, San Leandro, CA (US)

Correspondence Address: IPSG, P.C., P.O. BOX 700640, SAN JOSE, CA, 95170, US

(21) Appl. No.: 12/046,393

(22) Filed: Mar. 11, 2008

(51) Int. Cl. G05B 15/00; G05B 19/02; G01P 15/00; G06F 15/00

(52) U.S. Cl. 700/83; 340/825.24; 702/141; 702/150

(57) ABSTRACT

A method for controlling the playback of content and/or the ambience for the playback is disclosed. The method may include receiving user input from an actuated button, which may represent a first button or a second button of a control device. The method may also include receiving a signal pertaining to movement of the actuated button and/or motion of the control device. The method may also include translating the signal into an accelerate-forward command if the actuated button is the first button and the signal represents a first signal, into an accelerate-backward command if the actuated button is the first button and the signal represents a second signal, into a skip-forward command if the actuated button is the first button and the signal represents a third signal, and into a skip-backward command if the actuated button is the first button and the signal represents a fourth signal.

### BACKGROUND OF THE INVENTION

The present invention relates to controlling playback of media/content, such as video, audio, image, and/or text content. The invention also relates to controlling the ambience, such as the volume, the lighting, etc., associated with the content playback.

Conventionally, controlling content playback and ambience may involve utilizing a control device that includes many discrete, dedicated buttons for controlling various playback and ambience parameters, as illustrated in the example of FIG. 1.

FIG. 1 shows a schematic representation illustrating an example prior art control device 100. Control device 100 may include multiple dedicated buttons for controlling content playback. For example, control device 100 may include a fast-forward button 102, a fast-backward (or reverse) button 104, a skip-forward button 106, and a skip-backward button 108, in addition to the play, pause, stop, and record buttons. Control device 100 may also include multiple dedicated buttons for controlling ambience. For example, control device 100 may include a volume adjustment button 112 and a lighting adjustment button 114. The large amount of the dedicated buttons may lead to several disadvantages of control device 100.

As an example, the large amount of the dedicated buttons may make control device 100 inconvenient to use and may degrade user experience in consuming content/media. For instance, if a user of control device 100 would like to turn up the volume when watching a movie on a television, given that there are many buttons on control device 100, the user may have to turn his/her attention from the television to control device 100, find volume adjustment button 112 on control device 100, and then correctly press on the right-hand part of volume adjustment button 112 to increase the volume. Much inconvenience may be involved, and the user may miss a substantial portion of the movie.

The large amount of the dedicated buttons may also cause the form factor of control device 100 to be undesirably large. For usability and/or ergonomic considerations, the buttons may need to have sufficiently large sizes and separations. Accordingly, miniaturization of control device 100 may be obstructed by the sizes and the separations of the buttons. As a result, control device 100 may not be satisfactorily portable for users, and control device 100 may incur substantially high storage and shipping costs for the manufacturer of control device 100.

### SUMMARY OF INVENTION

An embodiment of the invention relates to a method for utilizing a control device to control the playback of content and/or the ambience for the playback. The method may include receiving user input from an actuated button. The actuated button may represent a first button or a second button of the control device. The method may also include receiving one or more signals pertaining to movement of the actuated button and/or motion of the control device. The method may also include translating the one or more signals into an accelerate-forward command for forwarding the content if the actuated button is the first button and the one or more signals include a first signal, into an accelerate-backward command for reversing the content if the actuated button is the first button and the one or more signals include a second signal, into a skip-forward command for forwarding the content according to a first set of section marks associated with the content if the actuated button is the first button and the one or more signals include a third signal, and into a skip-backward command for reversing the content according to at least one of the first set of section marks and a second set of section marks associated with the content if the actuated button is the first button and the one or more signals include a fourth signal.

The above summary relates to only one of the many embodiments of the invention disclosed herein and is not intended to limit the scope of the invention, which is set forth in the claims herein. These and other features of the present invention still be described in more detail below in the detailed description of the invention and in conjunction with the following figures.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1 shows a schematic representation illustrating an example prior art control device.

FIG. 2 shows a schematic representation illustrating a control device in accordance with one or more embodiments of the present invention.

FIG. 3 shows a schematic representation illustrating a control device in accordance with one or more embodiments of the present invention.

FIG. 4 shows a schematic representation illustrating a control device in accordance with one or more embodiments of the present invention.

FIG. 5 shows a flowchart illustrating a method for controlling content playback and/or ambience in accordance with one or more embodiments of the present invention.

FIG. 6 shows a flowchart illustrating a method for controlling content playback and/or ambience in accordance with one or more embodiments of the present invention.

FIG. 7 shows a flowchart illustrating a method for controlling content playback and/or ambience in accordance with one or more embodiments of the present invention.

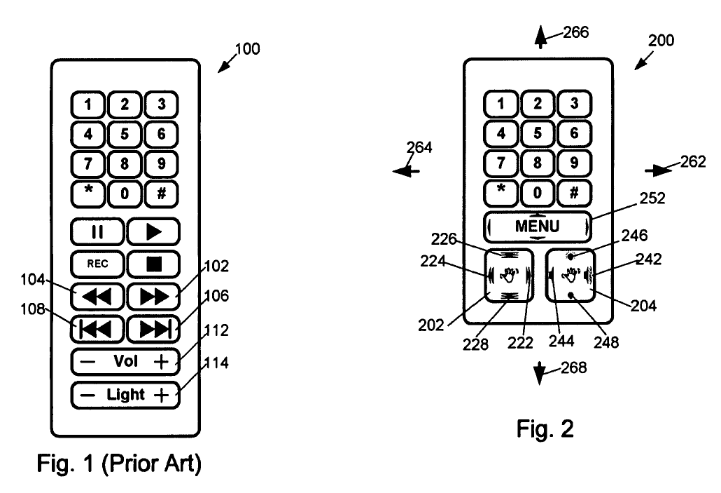

### DETAILED DESCRIPTION OF EMBODIMENTS

The present invention will now be described in detail with reference to a few embodiments thereof as illustrated in the accompanying drawings. In the following description, numerous specific details are set forth in order to provide a thorough understanding of the present invention. It will be apparent, however, to one skilled in the art, that the present invention may be practiced without some or all of these specific details. In other instances, well known process steps and/or structures have not been described in detail in order to not unnecessarily obscure the present invention.

Various embodiments are described herein below, including methods and techniques. It should be kept in mind that the invention might also cover articles of manufacture that includes a computer readable medium on which computer-readable instructions for carrying out embodiments of the inventive technique are stored. The computer readable medium may include, for example, semiconductor, magnetic, opto-magnetic, optical, or other forms of computer readable medium for storing computer readable code. Further, the invention may also cover apparatuses for practicing embodiments of the invention. Such apparatus may include circuits, dedicated and/or programmable, to carry out tasks pertaining to embodiments of the invention. Examples of such apparatus include a general-purpose computer and/or a dedicated computing device when appropriately programmed and may include a combination of a computer/computing device and dedicated/programmable circuits adapted for the various tasks pertaining to embodiments of the invention.

One or more embodiments of the present invention relate to a method for controlling content playback and ambience. The method may enable reducing the number of buttons in control devices, thereby improving the ease-of-use and reducing the form factors of the control devices.

The method may include providing a media-control button and an ambience-control button for a control device. The method may also include receiving user input from one of the media-control button and the ambience-control button, which may be referred to as the actuated button. The method may also include receiving one or more signals pertaining to the movement of the actuated button and/or the motion of the control device. The method may also include identifying which one of the media-control button and the ambience-control button is actuated and, accordingly, translating the one or more signals into a desirable media-control or ambience-control command. For example, the media-control or ambience-control command may represent one of the fast-forward (or accelerate-forward), fast-backward (or accelerate-backward or reverse), skip-forward, skip-backward, increase-volume, decrease-volume, increase-lighting, and decrease-lighting commands associated with buttons 102, 104, 106, 108, 112, and 114 of the example prior art control device 100.

As can be readily appreciated from the above discussion, the method may reduce the number of media/ambience-control buttons from 6 (e.g., buttons 102-114) to 2 (e.g., the media-control button and the ambience-control button). Accordingly, the method may effectively improve the convenience for users in operating control devices and may enable reducing the sizes of control devices.

One or more embodiments of the present invention may relate to a control device. The control device may include a media-control button and an ambience-control button. The control device may also include one or more sensing mechanisms, such as one or more joystick sensors, capacitive sensors, pressure sensors, gyroscopes, and/or accelerometers, for generating one or more signals pertaining to the movement of the media-control button, the movement of the ambience-control button, and/or the motion of the control device in response to user operation. The control device may also include a processing/logic unit for determining which one of the media-control button and the ambience-control has been actuated and, accordingly, translating the one or more signals into a suitable media-control or ambience control command.

The features and advantages of the invention may be better understood with reference to the figures and discussions that follow.

FIG. 2 shows a schematic representation illustrating a control device 200 in accordance with one or more embodiments of the present invention. Control device 200 may include a “menu” button 252 for activating one or more on-screen menus, for example, to be displayed on a television screen. “Menu” button 252 may also enable a user of control device 200 to navigate the one or more menus for choosing options or providing commands. For example, “menu” button 252 may represent a multi-way button (or joystick), for example, implemented utilizing one or more joystick sensors, capacitive sensors, and/or pressure sensors, for controlling the movement of an on-screen pointer or the indication/highlighting of menu items. Alternatively or additionally, control device 200 may include one or more motion-sensing mechanisms, such as one or more accelerometers and/or gyroscopes, for facilitating the user of control device 200 to navigate menus and/or to select menu items through various gestures that cause various motions of control device 200.

Control device 200 may also include a media-control button 202 and an ambience-control button 204. Media-control button 202 may represent a multi-way button (or joystick) including at least four media-control portions, e.g., a portion 222, a portion 224, a portion 226, and a portion 228, for receiving user input to generate signals associated with at least four media-control commands, e.g., a fast-forward (or accelerate-forward) command, a fast-backward (or accelerate-backward) command, a skip-forward command, and a skip-backward command, respectively. Alternatively or additionally, one or more of the media-control portions may be associated with one or more other media-control commands. Ambience-control button 204 may represent a multi-way button (or joystick) including at least four ambience-control portions, e.g., a portion 242, a portion 244, a portion 246, and a portion 248, for receiving user input to generate signals associated with at least four ambience-control commands, e.g., an increase-volume command, a decrease-volume command, an increase-lighting command, and a decrease-lighting command, respectively. Alternatively or additionally, one or more of the ambience-control portions may be associated with one or more other ambience-control commands, such as an increase-temperature command, a decrease-temperature command, a open-blinds command, and/or a close-blinds command.

Control device 200 may include additional sensing mechanisms, such as one or more joystick sensors, capacitive sensors, and/or pressure sensors, coupled with media-control button 202 and/or ambience-control button 204 for generating more sophisticated control signals. For example, the amount of the capacitance and/or the pressure resulted from the user input received at portion 222 of media-control button 202 may be translated into a fast-forward speed at which the consumed content is to be fast-forwarded; the amount of the capacitance and/or the pressure resulted from the user input received at portion 242 of ambience-control button 204 may be translated into a volume-increase speed/rate at which the volume for playing back content is to be increased.

Additionally or alternatively, the one or more motion-sensing mechanisms of control device 200 may enable the user to provide sophisticated media-control and ambience-control commands utilizing various gestures that cause various motions of control device 200. For example, the signals related to the motions of control device 200 in directions 262 (to the right), 264 (to the left), 266 (forward), and 268 (backward) may be translated into the fast-forward command, the fast-backward command, the skip-forward command, and the skip-backward command, respectively, if media-control button 202 is actuated (e.g., pressed or touched) or into the increase-volume command, the decrease-volume command, the increase-lighting command, and the decrease lighting command, respectively, if ambience-control button 204 is actuated. The acceleration of the motion of control device 200 in each of the directions may be translated into the acceleration, the speed (or change rate), and/or the amount of the associated action.

Control device 200 may also include a processing/logic unit for determining which one of media-control button 202 and ambience-control 204 has been actuated and, accordingly, translating signals into suitable media-control and/or ambience control commands.

In comparison with the example prior art control device 100, which requires six buttons for media control and ambience control, control device 200 needs only two buttons for media control and ambience control. Accordingly, the form factor of control device 200 may be substantially smaller than the form factor of control device 100. Advantageously, control device 200 may provide superior portability; control device 200 may require lower storage and shipping costs.

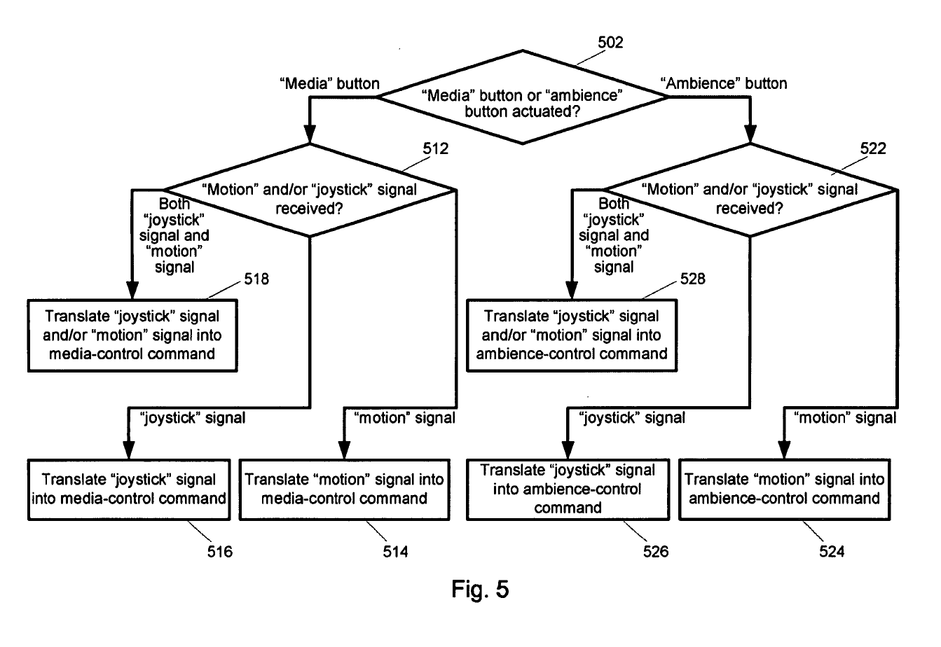

Example operation methods, features, and advantages of control device 200 are further discussed below with reference to the example of FIG. 5.

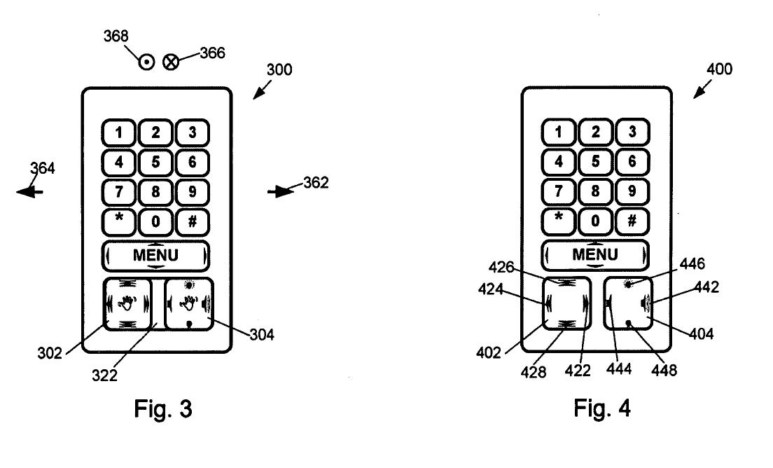

FIG. 3 shows a schematic representation illustrating a control device 300 in accordance with one or more embodiments of the present invention. Control device 300 may include a media-control button 302 and an ambience-control button 304. Each of media-control button 302 and ambience-control button 304 may represent a simple on/off button for a user of control device 300 to activate/deactivate media control or ambience control. In one or more embodiments, media-control button 302 and ambience-control button 304 may represent two portions of a multi-way (e.g., two-way or three-way) button 322.

Control device 300 may also include one or more motion-sensing mechanisms, such as one or more accelerometers and/or gyroscopes, for enabling a user of control device 300 to provide sophisticated media-control and ambience-control commands through various gestures that cause various motions of control device 300. For example, the signals related to the motions of control device 300 in directions 362 (to the right), 364 (to the left), 366 (downward), and 368 (upward) may be translated into a fast-forward command, a fast-backward command, a skip-forward command, and a skip-backward command, respectively, if media-control button 302 is actuated (e.g., pressed or touched) or into an increase-volume command, a decrease-volume command, an increase-lighting command, and a decrease lighting command, respectively, if ambience-control button 304 is actuated. The acceleration of the motion of control device 300 in each of the directions may be translated into the acceleration, the speed (or change rate), and/or the amount of the associated action.

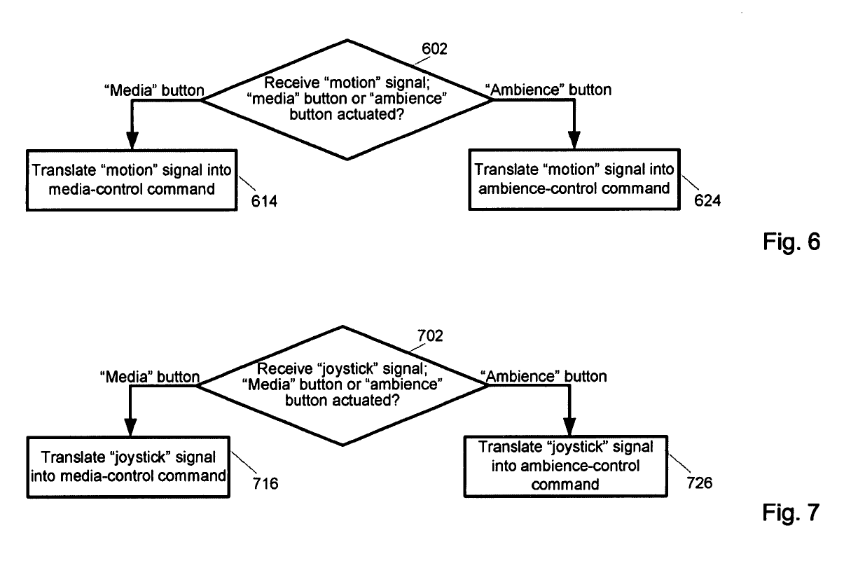

Control device 300 may also have substantial convenience and form-factor advantages over the example prior art control device 100. Example operation methods, features, and advantages of control device 300 are further discussed below with reference to the example of FIG. 6.

FIG. 4 shows a schematic representation illustrating a control device 400 in accordance with one or more embodiments of the present invention. Control device 400 may include a media-control button 402 and an ambience-control button 404. Media-control button 402 may represent a multi-way button (or joystick) including at least four portions, e.g., a portion 422, a portion 424, a portion 426, and a portion 428, for receiving user input to generate signals associated with at least four media-control commands, e.g., a fast-forward (or accelerate-forward) command, a fast-backward (or accelerate-backward) command, a skip-forward command, and a skip-backward command, respectively. Ambience-control button 404 may represent a multi-way button (or joystick) including at least four portions, e.g., a portion 442, a portion 444, a portion 446, and a portion 448, for receiving user input to generate signals associated with at least four ambience-control commands, e.g., an increase-volume command, a decrease-volume command, an increase-lighting command, and a decrease-lighting command, respectively.

Control device 400 may include additional sensing mechanisms, such as one or more joystick sensors, capacitive sensors, and/or pressure sensors, coupled with media-control button 402 and/or ambience-control button 404 for generating more sophisticated control signals. For example, the amount of the capacitance and/or the pressure resulted from the user input received at portion 428 of media-control button 402 may be translated into a skip-backward speed at which certain content is to be skipped backwards according to a set of section/chapter marks associated with the content; the amount of the capacitance and/or the pressure resulted from the user input received at portion 448 of ambience-control button 404 may be translated into a lighting-decrease speed/rate at which the lighting in the room for playing back certain content is to be decreased.

Control device 400 may also have substantial convenience and form-factor advantages over the example prior art control device 100. Example operation methods, features, and advantages of control device 400 are further discussed below with reference to the example of FIG. 7.

FIG. 5 shows a flowchart illustrating a method for controlling content playback and/or ambience in accordance with one or more embodiments of the present invention. The method may be implemented, for example, utilizing control device 200 illustrated in the example of FIG. 2. The method may, start with step 502, in which control device 200 (or the processing/logic unit therein) may determine which one of media-control button 202 and ambience-control button 204 is actuated (e.g., pressed or touched). Control device 200 may identify the actuated button when or after one or more signals are provided by one or more sensing mechanisms in control device 200. If media-control button 202 is actuated, control may be transferred to step 512; if ambience-control button 204 is actuated, control may be transferred to step 522.

In step 512, control device 200 (and/or the media playback device controlled by control device 200) may determine whether one or more signals pertaining to the motion of control device 200 (referred to as one or more “motion” signals) or one or more signals pertaining to the movement of media-control button 202 (referred to as one or more “joystick” signals) have been received. If one or more “motion” signals (but no “joystick” signals) have been received, control may be transferred to step 514; if one or more “joystick” signals (but not “motion” signals) have been received, control may be transferred to step 516; if one or more “motion” signals and one or more “joystick” signals have been received, control may be transferred to step 518.

In step 514, control device 200 (and/or the controlled media playback device) may translate the one or more “motion” signals into a media-control command. The one or more “motion” signals may include one or more direction signals and/or one or more magnitude signals. The one or more direction signals may be translated into one of the accelerate-forward (or fast-forward), accelerate-backward (or fast-backward), skip-forward, and skip-backward function commands. The one or more magnitude signals may be translated into a magnitude (e.g., acceleration, speed, and/or amount) command associated with the function command determined based on the one or more direction signals. The media-control command may include the function command and/or the magnitude command. As an example, if the one or more “motion” signals include a direction/orientation signal associated with direction 264, the one or more “motion” signals may be translated into the accelerate-backward (or fast-backward) command for reversing the content played by the media playback device. The one or more “motion” signals may also include at least a magnitude signal (e.g., provided by the one or more motion-sensing mechanisms) related to the acceleration, the speed, and/or the distance of movement of control device 200 in direction 262. According to the magnitude signal, control device 200 (and/or the controlled media playback device) may adjust the acceleration, the speed, and/or the amount for reversing the content playback.

In step 516, control device 200 (and/or the controlled media playback device) may translate the one or more “joystick” signals into a media-control command. The one or more “joystick” signals may also include one or more direction signals and/or one or more magnitude signals. The one or more direction signals may be translated into one of the accelerate-forward (or fast-forward), accelerate-backward (or fast-backward), skip-forward, and skip-backward function commands. The one or more magnitude signals (e.g., provided by the one or more capacitive sensors and/or pressure sensors) may be translated into an associated magnitude (e.g., acceleration, speed, and/or amount) command. The media-control command may include the function command and/or the magnitude command. As an example, if the one or more “joystick” signals include a direction/orientation signal associated with portion 226, the one or more “joystick” signals may be translated into the skip-forward command for forwarding the content played by the media playback device according to a set of section/chapter marks associated With the content. The one or more “joystick” signals may also include at least a magnitude signal. According to the magnitude signal, control device 200 (and/or the controlled media playback device) may adjust the acceleration, the speed, and/or the amount for skip-forwarding the content playback.

In step 518, control device 200 (and/or the controlled media playback device) may translate the one or more “motion” signals and/or the one or more “joystick” signals into a media-control command. In one or more embodiments, the direction signals and/or the magnitude signals in the one or more “motion” signals and the one or more “joystick” signals may be combined based on a predetermined algorithm. In one or more embodiments, one of the one or more “motion” signals and the one or more “joystick” signals may be given priority, and the other may be ignored given the presence of the prioritized signal(s).

In step 522, control device 200 (and/or the controlled media playback device) may determine whether one or more “motion” signals or one or more “joystick” signals have been received. If one or more “motion” signals (but no “joystick” signals) have been received, control may be transferred to step 524; if one or more “joystick” signals (but no “motion” signals) have been received, control may be transferred to step 526; if one or more “motion” signals and one or more “joystick” signals have been received, control may be transferred to step 528.

In step 524, control device 200 (and/or the controlled media playback device) may translate the one or more “motion” signals into an ambience-control command. Step 524 may be similar to step 514. However, instead of being translated into a media-control function command, the one or more direction signals may be translated into one of several ambience-control function commands, such as the increase-volume, decrease-volume, increase-lighting, decrease-lighting, increase-temperature, decrease-temperature, open-blinds, and close-blinds function commands. The one or more magnitude signals may be translated into a magnitude (e.g., acceleration, change-rate, and/or amount) command associated with the function command determined based on the one or more direction signals. The ambience-control command may include the function command and/or the magnitude command.

In step 526, control device 200 (and/or the controlled media playback device) may translate the one or more “joystick” signals into an ambience-control command. Step 526 may be similar to step 524. However, instead of being translated into a media-control function command, the one or more direction signals may be translated into one of several ambience-control function commands.

In step 528, control device 200 (and/or the controlled media playback device) may translate the one or more “motion” signals and/or the one or more “joystick” signals into an ambience-control command. Step 528 may be similar to step 518. However, instead of being translated into a media-control command, the combination or the prioritized one of the one or more “motion” signals and/or the one or more “joystick” signals may be translated into an ambience-control command.

The method of the example FIG. 5 may enable the user to perform media control and ambience control utilizing either of “motion” signals and “joystick” signals. If the user's thumbs and/or other fingers are tired, the user may perform the controls utilizing “motion” signals; if the user's arm, elbow, or wrist is tired, or if the user would like to avoid interfering with other people sitting next to the user, the user may perform the controls utilizing “joystick” signals. Advantageously, flexibility and ergonomics may be optimized, and the fatigue of the user resulted from performing the controls may be reduced or prevented.

FIG. 6 shows a flowchart illustrating a method for controlling content playback and ambience in accordance with one or more embodiments of the present invention. The method may be implemented, for example, utilizing control device 300 illustrated in the example of FIG. 3. The method may start with step 602, in which control device 300 (and/or the playback device controlled by control device 300) by receive one or more “motion” signals from one or more motion-sensing mechanisms in control device 300. The one or more “motion” signals may include one or more direction signals and/or one or more magnitude signals similar to those discussed in step 514 in the example of FIG. 5. In step 602, control device 300 (and/or the controlled playback device) may also determine which one of media-control button 302 and ambience-control button 304 is actuated (e.g., pressed or touched). If media-control button 302 is actuated, control may be transferred to step 614; if ambience-control button 304 is actuated, control may be transferred to step 624.

Step 614 may be similar to step 514 in the example of FIG. 5. In step 614, control device 300 (or the controlled playback device) may translate the one or more “motion” signals into a media-control command, which may instruct the control playback device to perform a media-control action and may define the acceleration, the speed, and/or the amount associated with the media-control action. The media-control action may represent, for example, a fast-forward, fast-backward, skip-forward, or skip-backward action.

Step 624 may be similar to step 524 in the example of FIG. 5. In step 624, control device 300 (or the controlled playback device) may translate the one or more “motion” signals into an ambience-control command, which may instruct the control playback device to perform an ambience-control action and may define the acceleration, the speed (or change rate), and/or the amount associated with the ambience-control action. The ambience-control action may represent, for example, an increase-volume, decrease-volume, increase-lighting, or decrease-lighting action.

The method of the example FIG. 6 may enable the user to perform media control and ambience control utilizing simple, intuitive gestures. The user may not need to look at the buttons in performing the controls. Advantageously, the controls may be easily performed, and the user may not be substantially distracted from the content that the user is watching or listening to.

FIG. 7 shows a flowchart illustrating a method for controlling content playback and ambience in accordance with one or more embodiments of the present invention. The method may be implemented, for example, utilizing control device 400 illustrated in the example of FIG. 4. The method may start with step 702, in which control device 400 (and/or the playback device controlled by control device 400) by receive one or more “joystick” signals from one or more joystick sensor(s), capacitive sensor(s), and/or pressure sensor(s) in control device 400. The one or more “joystick” signals may include one or more direction signals and/or one or more magnitude signals similar to those discussed in step 516 in the example of FIG. 5. In step 702, control device 400 (and/or the controlled playback device) may also determine which one of media-control button 402 and ambience-control button 404 is actuated (e.g., pressed or touched). If media-control button 402 is actuated, control may be transferred to step 716; if ambience-control button 404 is actuated, control may be transferred to step 726.

Step 716 may be similar to step 516 in the example of FIG. 5. In step 716, control device 400 (or the controlled playback device) may translate the one or more “joystick” signals into a media-control command, which may instruct the control playback device to perform a media-control action and may define the acceleration, the speed, and/or the amount associated with the media-control action. The media-control action may represent, for example, a fast-forward, fast-backward, skip-forward, or skip-backward action.

Step 726 may be similar to step 526 in the example of FIG. 5. In step 726, control device 400 (or the controlled playback device) may translate the one or more “joystick” signals into an ambience-control command, which may instruct the control playback device to perform an ambience-control action and may define the acceleration, the speed (or change rate), and/or the amount associated with the ambience-control action. The ambience-control action may represent, for example, an increase-volume, decrease-volume, increase-lighting, or decrease-lighting action.

The method of the example FIG. 7 may enable the user to perform media control and ambience control utilizing only thumb movement without substantially moving the user's, wrist, elbow, or arm. Since there are only one button for each of media control and ambience control, the user may not need to look at the buttons in performing the controls. Advantageously, the controls may be easily performed, and the user may not be substantially distracted from the content that the user is watching or listening to.

As can be appreciated from the foregoing, embodiments of the invention may effectively reduce the number of buttons required for control devices. Accordingly, embodiments of the invention may reduce complexity and inconvenience in controlling media/content playback and ambience. Embodiments of the invention may also optimize flexibility and ergonomics for users in performing media control and ambience control. Advantageously, ease of use and satisfactory user experience may be provided.

Embodiments of the invention may also reduce the form factors of control devices. Advantageously, portability of the control devices may be improved, and the storage and shipping costs for the control devices may be reduced.

While this invention has been described in terms of several embodiments, there are alterations, permutations, and equivalents, which fall within the scope of this invention. It should also be noted that there are many alternative ways of implementing the methods and apparatuses of the present invention. Furthermore, embodiments of the present invention may find utility in other applications. The abstract section is provided herein for convenience and, due to word count limitation, is accordingly written for reading convenience and should not be employed to limit the scope of the claims. It is therefore intended that the following appended claims be interpreted as including all such alterations, permutations, and equivalents as fall within the true spirit and scope of the present invention.

What is claimed is:

1. A method for controlling, using a control device, at least one of playback of content and ambience for the playback of the content, the method comprising:
receiving user input from an actuated button, the actuated button being one of a first button and a second button of the control device;
receiving one or more signals pertaining to at least one of movement of the actuated button and motion of the control device;
translating the one or more signals into an accelerate-forward command for forwarding the content if the actuated button is the first button and the one or more signals include a first signal;
translating the one or more signals into an accelerate-backward command for reversing the content if the actuated button is the first button and the one or more signals include a second signal;
translating the one or more signals into a skip-forward command for forwarding the content according to a first set of section marks associated with the content if the actuated button is the first button and the one or more signals include a third signal; and
translating the one or more signals into a skip-backward command for reversing the content according to at least one of the first set of section marks and a second set of section marks associated with the content if the actuated button is the first button and the one or more signals include a fourth signal.

2. The method of claim 1 further comprising:
determining a direction related to the motion of the control device; and
translating at least the direction into at least one of the first signal, the second signal, the third signal, and the fourth signal.

3. The method of claim 2 further comprising selecting one from the accelerate-forward command, the accelerate-backward command, the skip-forward command, and the skip-backward command based on the direction.

4. The method of claim 1 further comprising:
determining an acceleration amount pertaining to the motion of the control device; and
translating at least the acceleration amount into at least one of the first signal, the second signal, the third signal, and the fourth signal.

5. The method of claim 4 further comprising adjusting at least one of an accelerate-forward speed, an accelerate-backward speed, a skip-forward speed, and a skip-backward speed of the content playback according to the acceleration amount.

6. The method of claim 4 further comprising adjusting at least one of an accelerate-forward amount, an accelerate-backward amount, a skip-forward amount, and a skip-backward amount of the content playback according to the acceleration amount.

7. The method of claim 1 further comprising:
determining a direction related to the movement of the actuated button; and
translating at least the direction into at least one of the first signal, the second signal, the third signal, and the fourth signal.

8. The method of claim 7 further comprising selecting one from the accelerate-forward command, the accelerate-backward command, the skip-forward command, and the skip-backward command based on the direction.

9. The method of claim 1 further comprising:
determining an pressure amount resulted from the movement of the actuated button; and
translating at least the pressure amount into at least one of the first signal, the second signal, the third signal, and the fourth signal.

10. The method of claim 9 further comprising adjusting at least one of an accelerate-forward speed, an accelerate-backward speed, a skip-forward speed, a skip-backward speed, an accelerate-forward amount, an accelerate-back ward amount, a skip-forward amount, and a skip-backward amount of the content playback according to the pressure amount.

11. The method of claim 1 further comprising:
translating the one or more signals into an increase-volume command for increasing volume associated with the playback if the actuated button is the second button and the one or more signals include the first signal;
translating the one or more signals into a decrease-volume command for decreasing the volume if the actuated button is the second button and the one or more signals include the second signal;
translating the one or more signals into an increase-lighting command for increasing lighting associated with the playback if the actuated button is the second button and the one or more signals include the third signal; and
translating the one or more signals into a decrease-lighting command for decreasing the lighting if the actuated button is the second button and the one or more signals include the fourth signal.

12. The method of claim 11 further comprising:
determining a direction related to the motion of the control device; and
selecting one from the increase-volume command, the decrease-volume command, the increase-lighting command, and the decrease-lighting command based on the direction.

13. The method of claim 11 further comprising:
determining an acceleration amount pertaining to the motion of the control device;
adjusting at least one of a volume-increase speed, a volume-decrease speed, a lighting-increase speed, a lighting-decrease speed, a volume-increase amount, a volume-decrease amount, a lighting-increase amount, and a lighting-decrease amount of the ambience according to the acceleration amount.

14. The method of claim 1 further comprising:
translating the one or more signals into an increase-volume command if the actuated button is the second button and the one or more signals include a fifth signal;
translating the one or more signals into a decrease-volume command if the actuated button is the second button and the one or more signals include a sixth signal;
translating the one or more signals into an increase-lighting command if the actuated button is the second button and the one or more signals include a seventh signal; and
translating the one or more signals into a decrease-lighting command if the actuated button is the second button and the one or more signals include a eighth signal.

15. The method of claim 14 further comprising:
determining a direction related to the movement of the actuated button;
determining a pressure amount resulted from the movement of the actuated button; and
translating at least the direction and the pressure amount into at least one of the first signal, the second signal, the third signal, and the fourth signal.

16. The method of claim 14 further comprising:
determining a direction related to the movement of the actuated button; and
selecting one from the increase-volume command, the decrease-volume command, the increase-lighting command, and the decrease-lighting command based on the direction.

17. The method of claim 14 further comprising:
determining an pressure amount resulted from the movement of the actuated button; and
adjusting at least one of a volume-increase speed, a volume-decrease speed, a lighting-increase speed, a lighting-decrease speed, a volume-increase amount, a volume-decrease amount, a lighting-increase amount, and a lighting-decrease amount of the ambience according to the pressure amount.

18. The method of claim 1 further comprising determining whether the one or more signals pertain to the movement of the actuated button or pertain to the motion of the control device.

19. The method of claim 1 wherein the one or more signals pertain to the motion of the control device but not the movement of the actuated button.

20. The method of claim 1 wherein the one or more signals pertain to the movement of the actuated button but not the motion of the control device.
